(19) United States
(12) Patent Application Publication
(10) Pub. No.: US 2015/0363812 A1
(43) Pub. Date: Dec. 17, 2015

(54) COUPON CONSOLIDATION SYSTEM AND METHOD

(71) Applicant: James MCMILLAN, Union City, NY (US)

(72) Inventor: James MCMILLAN, Union City, NY (US)

(21) Appl. No.: 14/741,881

(22) Filed: Jun. 17, 2015

Related U.S. Application Data
(60) Provisional application No. 62/013,208, filed on Jun. 17, 2014.

(51) Int. Cl. G06Q 30/02

(52) U.S. Cl. CPC G06Q 30/0225

(57) ABSTRACT

A system for presenting a plurality of coupons at a retail check-out includes a server having a database storing coupon data related to a plurality of coupons, each associated with at least one product. The coupon data for each includes at least a product ID and a redemption value. A user interface is operated and displayed by a customer computing device and is configured to accept an input by the customer of an identification code for each of a plurality of customer-selected products and send the identification codes to the server. The server is configured to search the database for coupons associated with the customer-selected products, create a single machine-readable consolidated coupon code from coupons located in the search, and send the consolidated coupon code to the customer computing device for presentation to a cashier to obtain the redemption values during a purchase of the customer-selected products.

### CROSS-REFERENCE TO RELATED APPLICATIONS

This application claims priority to U.S. Provisional Patent Application No. 62/013,208, filed Jun. 17, 2014, currently pending, entitled “Coupon Consolidation System and Method,” the entire contents of which are incorporated by reference herein.

### BACKGROUND OF THE INVENTION

Embodiments of the present invention relate generally to a system and method for using coupons, and more particularly, to a system and method for consolidating a plurality of coupons into a single machine readable code.

It is estimated that about four hundred billion coupons are distributed each year in the United States. With the average face value of each coupon being more than a dollar, customers are given incredible opportunities to significantly reduce their shopping costs. However, it is estimated that despite the potential savings, less than 2% of the distributed coupons are ever redeemed. Even more troubling are studies which show that the customers most likely to benefit from coupon redemption, such as families living on food stamps, are unlikely to use coupons while shopping.

Reasons for the lack of coupon use can vary. Recent television programming has highlighted customers who use vast amounts of coupons to cut whopping $400 grocery bills by 75% or more, but such individuals are rare. One major reason for the discrepancy may be that more than 80% of the distributed coupons are made available through newspapers or other print media, requiring that the coupons be manually located and cut in order to be used. This can be a time consuming process for the customer. In addition, it can be equally time consuming for a clerk at a retailer to scan each individual coupon.

Recently, companies have used websites as centralized coupon caches, where customers can more quickly search for specific coupons. However, in order to use coupons found online, the customer typically still must print each individual coupon, or save each coupon individually on a mobile device for presentation at check out. The retailer still must scan each coupon individually.

In addition, the redemption process by the retailer can be equally time consuming. Retailers must take the collected paper coupons and send them to headquarters, manufacturers, or coupon clearinghouses (many of which are in Mexico). The coupons are laid out and the total reimbursement to the retailer is calculated by counting the individual coupons. Moreover, the redemption process is fraught with opportunities for fraud.

It is therefore desirable to provide a system and method for customers to quickly and efficiently collect and redeem coupons to effect savings while shopping. It is also desirable to provide a system and method whereby retailers can more efficiently redeem used coupons without the prospect of fraud.

### BRIEF SUMMARY OF THE INVENTION

Briefly stated, an embodiment of the present invention comprises a system for presenting a plurality of coupons at a retail check-out. The system includes a server having a database storing coupon data related to a plurality of coupons. Each of the coupons is associated with at least one of a plurality of products available for purchase at one or more retailers. The coupon data for each of the plurality of coupons includes at least a product ID and a redemption value. A user interface is operated and displayed by a customer computing device in communication with the server. The user interface is configured to accept an input by the customer of an identification code for each of a plurality of customer-selected products and send the identification codes for the plurality of customer-selected products to the server. The server is configured to: (i) search the database, using the received identification codes, for coupons associated with the customer-selected products; (ii) create a single machine-readable consolidated coupon code from two or more coupons located in the search, the consolidated coupon code including the product ID and redemption value for each of the two or more coupons located in the search, and (iii) send the consolidated coupon code to the customer computing device for presentation to a cashier to obtain the redemption values of the two or more coupons during a purchase of the plurality of customer-selected products.

Another embodiment of the present invention comprises a method for presenting a plurality of coupons at a retail check-out. The method includes providing, in a server, a database storing coupon data related to a plurality of coupons. Each of the coupons is associated with at least one of a plurality of products available for purchase at one or more retailers. The coupon data for each of the plurality of coupons includes at least a product ID and a redemption value. The method further includes receiving, at the server from a customer computing device, identification codes for each of a plurality of customer-selected products, searching, by the server, the database, using the received identification codes, for coupons associated with the customer-selected products, and creating, by the server, a single machine-readable consolidated coupon code from two or more coupons located in the search. The consolidated coupon code includes the product ID and redemption value for each of the two or more coupons located in the search. The method further includes sending, by the server, the consolidated coupon code to the customer computing device for presentation to a cashier to obtain the redemption values of the two or more coupons during a purchase of the plurality of customer-selected products.

Yet another embodiment of the present invention comprises a method for presenting a plurality of coupons at a retail check-out. The method includes providing a user interface operated and displayed by a customer computing device in communication with a server. The server includes a database storing coupon data related to a plurality of coupons. Each of the coupons is associated with at least one of a plurality of products available for purchase at one or more retailers. The coupon data for each of the plurality of coupons includes at least a product ID and a redemption value. The method further includes accepting, by the user interface, an input by the customer of an identification code for each of a plurality of customer-selected products, sending, by the customer computing device, the identification codes for the plurality of customer-selected products to the server, and receiving, at the customer computing device from the server, a single machine-readable consolidated coupon code from two or more coupons located in a search conducted by the server of the database for coupons associated with the customer-selected products using the sent identification codes. The consolidated coupon code includes the product ID and redemption value for each of the two or more coupons located in the search. The method further includes presenting, by the user interface on a display of the customer computing device, the consolidated coupon code to a cashier to obtain the redemption values of the two or more coupons during a purchase of the plurality of customer-selected products.

### BRIEF DESCRIPTION OF THE SEVERAL VIEWS OF THE DRAWINGS

The following detailed description of preferred embodiments of the invention will be better understood when read in conjunction with the appended drawings. For the purpose of illustration, there are shown in the drawings embodiments which are presently preferred. It should be understood, however, that the invention is not limited to the precise arrangements and instrumentalities shown.

In the drawings:

FIG. 1 is a schematic block diagram of a system for coupon consolidation in accordance with a preferred embodiment of the present invention;

FIG. 2 is a first screenshot of an application for use with a system such as that shown in FIG. 1;

FIG. 3 is a second screenshot of the application of FIG. 2; and

FIG. 4 is a flow chart of an application for redeeming coupons in accordance with a preferred embodiment of the present invention.

### DETAILED DESCRIPTION OF THE INVENTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the device and designated parts thereof. The terminology includes the above-listed words, derivatives thereof, and words of similar import. Additionally, the words “a” and “an”, as used in the claims and in the corresponding portions of the specification, mean “at least one.”

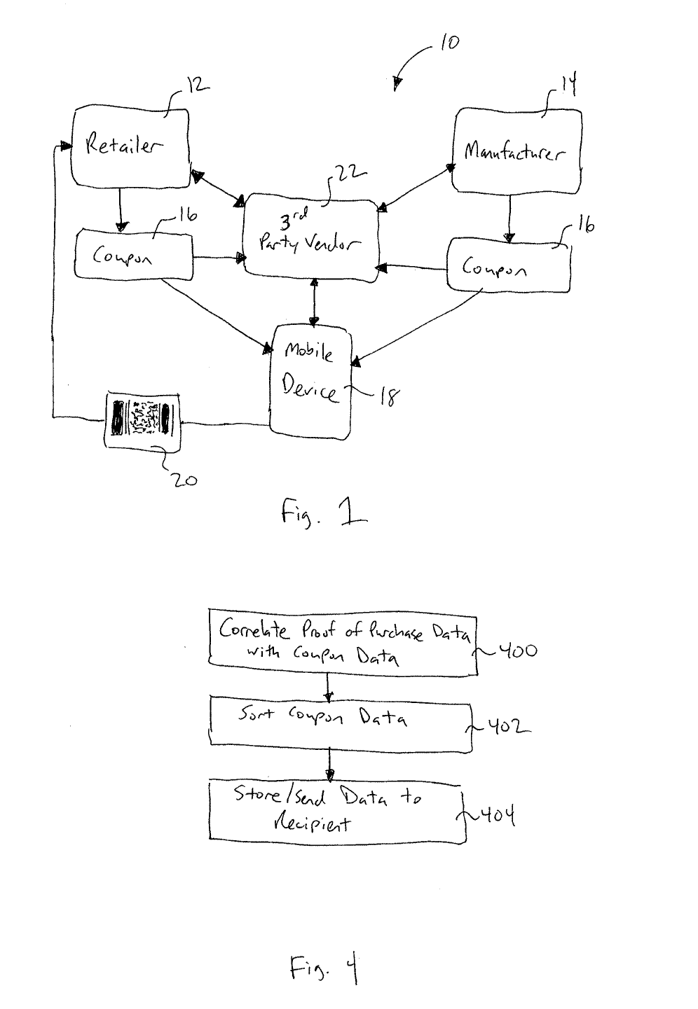

Referring to FIG. 1, there is shown a system 10 in accordance with a first preferred embodiment of the present invention. The system 10 includes at least one retailer 12 in the business of supplying customers with goods and/or services, such as a supermarket, clothing store, sporting goods store, restaurant, or the like. The retailer 12 may purchase and re-sell products from one or more product manufacturers 14. The manufacturer 14 may issue one or more coupons 16 associated with the products produced thereby, such that each coupon 16 entitles the holder to a rebate, discount, or the like on the purchase price of a product bought either directly from the manufacturer 14 or from a retailer 12. Similarly, the retailer 12 may issue one or more coupons 16 associated with products sold thereby, such that the holder is entitled to a rebate, discount, or the like on the purchase price of products bought from the retailer 12. The coupons 16 may be in paper form, electronic form, or the like, and preferably include a unique code, which can be alphanumeric, machine-readable, or the like, containing the data necessary to apply the rebate, discount, or the like.

The coupons 16 may be obtained by a customer having a mobile device 18 (e.g., a smartphone, PDA, tablet computer, or the like) which is configured to display a consolidated machine readable coupon code 20 incorporating the necessary data from each of the coupons 16. The customer preferably presents the consolidated code 20 to the retailer 12, at a point-of-sale (POS) terminal (not shown) or the like during check-out. The retailer 12 scans the consolidated coupon code 20 and preferably applies all of the applicable rebates, discounts, or the like to the customer's purchase as if the customer had presented the retailer 12 with all of the individual coupons 16 that are represented by the consolidated coupon code 20.

The consolidated coupon code 20 is preferably in the form of a two- or three-dimensional bar code, such as a stacked barcode, PDF417, QR code, or the like. These types of codes are preferred because of their ability to store large data sets (which is important depending on the number of coupons 16 utilized by the customer) and because most POS terminals are equipped to scan and receive coupon information using bar code scanners. However, it is contemplated that other types of machine-readable code may be used with the invention as well, such as linear bar codes, magnetic strips, radio identification tags, or the like.

The coupons 16 may be retrieved and incorporated into the consolidated coupon code 20 in any number of ways. In a preferred method, a third party vendor 22 may provide a number of services to allow the customer to obtain the consolidated coupon code 20. It is preferred that the third party vendor 22 provides customer access to a user interface, such as a website, mobile application, or the like to facilitate creation of the consolidated coupon code 20. For example, the customer may access a website using the mobile device 18 or download an application to the mobile device 18.

In another example, the user interface may be provided as an API that can be integrated into other websites or applications. For example, a consolidated coupon API can be provided to utilize the below-described functionality via a retailer website or application, manufacturer website or application, discount websites or applications, or through social media websites or applications, such as FACEBOOK, TWITTER, LINKEDIN, or the like.

The third party vendor 22 may maintain a database in a server or other computer storage (not shown) that stores information regarding products, retailers 12, manufacturers 14, coupons 16, and the like. It is preferred that the database is not sent or stored in the mobile device 18 as the memory requirements may be large and overly burdensome for the customer. Thus, when access to the database is required during execution of an application on the mobile device 18, for example, the mobile device 18 preferably connects over a network (e.g., Internet, LAN, WAN, or the like) to a server or other storage of the third party vendor 22. However, portions of the database may be sent to the customer in response to a request, on a periodic basis, or the like. For example, based on geolocation information from the mobile device 18, information for nearby retailers 12 and relevant coupons 16 can be downloaded to the mobile device 18 for faster access.

Thus, it is preferred that manufacturers 14 and retailers 12 send coupon 16 information to the third party vendor 22 for maintenance in the database. In this way, customers can quickly and efficiently locate relevant coupons 16 at a single, centralized location, rather than having to hunt through circular ads, browse multiple websites, and the like. However, as will be described in further detail below, coupons 16 may be utilized by the customer in other ways aside from the storage of coupons 16 in the database.

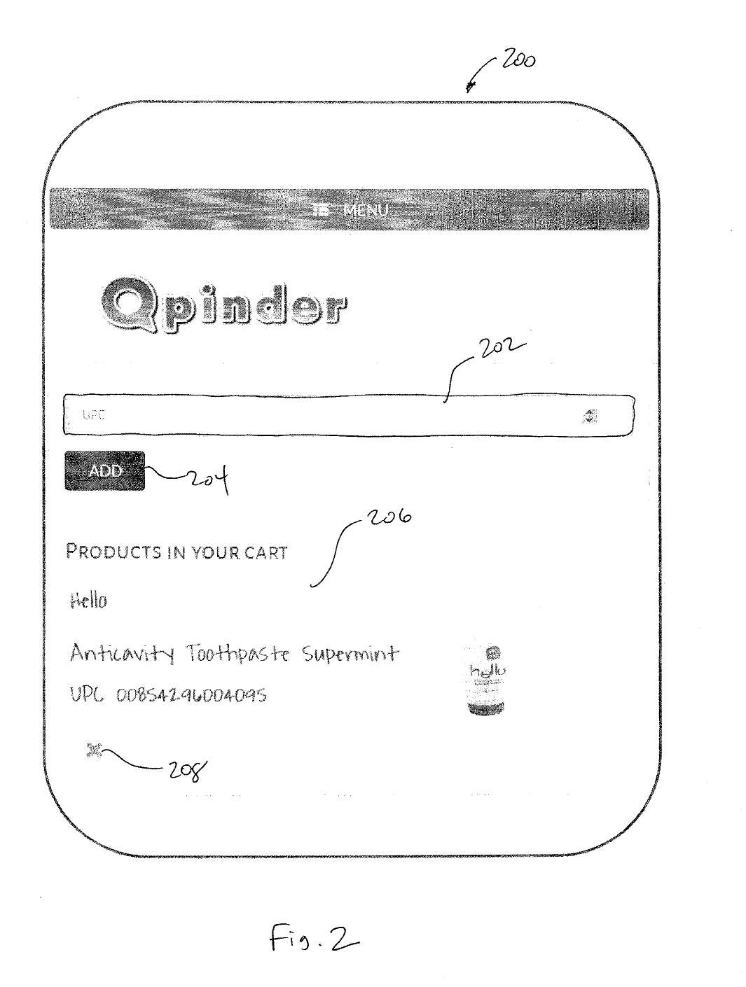

In one embodiment, while the customer is shopping at the retailer 12, the customer may use the mobile device 18 to scan products (using a camera phone or other machine code reader) or manually enter product information (e.g., name, description, UPC, or the like). FIG. 2 is a screenshot 200 of an application executed on the mobile device 18. A text box 202 is provided for manual entry of a product UPC and an “add” button 204 to submit the selected product for entry into the “cart” 206 of products the customer is selecting for purchase. Products may be removed from the cart by selection of a “delete” button 208. Products may also be entered into the cart 206 by scanning the product UPCs with the mobile device 18.

Once a product is entered into the cart 206, the application preferably initiates a search of the database to determine whether any coupons 16 exist that are relevant to the entered product. If one or more coupons 16 for the product are found, the data from the relevant coupon(s) 16 may be queued for entry into the final consolidated coupon code 20. The customer may also be given the option to use the coupon 16 or discard it if the customer is not satisfied. If no relevant coupons 16 are found, the customer may be alerted or the application may simply proceed to await the next product. It is further contemplated that the application need not search for coupons 16 immediately upon entry of a product, but may instead await a customer command to do so or may simply conduct the search when the customer indicates that shopping is completed, at which point the application may initiate a search of the database for all of the products at once.

In addition to searching for coupons 16 relevant to a specific product, or in the event that no relevant coupon 16 is found, the application may also search for coupons 16 that are available for other products from the same manufacturer 14, other products from the retailer 12 at which the customer is shopping, similar or related products, or the like. It is also preferred that the customer be alerted if the customer is required to meet certain additional conditions in order to obtain the rebate, discount, or the like. For example, if the customer must purchase two of the same product in order to use the relevant coupon 16, the application will preferably alert the customer to this requirement.

It is further preferred that the customer is provided with the ability to manually search for coupons 16 associated with desired products, particular retailers 12, particular manufacturers 14, or the like. For example, a customer may create a shopping list based on coupons 16 that are listed as being presently available at a particular retailer 12. In this way, the customer can not only get the benefit of locating coupons 16 during shopping, but can also plan shopping trips ahead of time using the searching features.

Alternatively or in addition to the database, customers can preferably enter paper coupons 16 for inclusion in the consolidated coupon code 20 by scanning or manually entering the codes on the coupons 16 into the mobile device 18. For electronic coupons 16 available from e-mail, other websites, or the like, the customer can also preferably manually enter the codes or upload/download the electronic coupons to the third party vendor 22 website, the application, or the like. The application, website, or the like can then convert the information into the necessary data for inclusion in the consolidated coupon code 20. In some embodiments, coupons 16 entered by the customer may be added to the database.

In another embodiment, rather than storing coupons in the database, following receipt of product identification, the third party vendor 22 may, via its server or other computing devices, make a search of a network, such as the Internet, for coupons from other sources, such as manufacturer websites, discount websites, or the like. Any coupons located as a result of the search may be presented to the customer via the user interface. Upon selection, the relevant coupon data may be retrieved for compiling with the consolidated coupon code 20.

While FIG. 2 and the above description are generally in reference to an application on the customer's mobile device 18, the method and interface can also be implemented on a website accessible by the mobile device 18 or other computer device. All or portions of the application, website, or the like may be stored and executed on the mobile device 18, on a remote server, or the like.

In another embodiment, the third party vendor 22 can make kiosks or other computing stations (not shown) available at select locations, such as at a retailer 12, where customers may bring coupons 16 for scanning or manual entry to obtain consolidated coupon codes 20. Such kiosks may also preferably provide searching capabilities and access to the database as described above.

In one embodiment, coupons 16 may be suggested to the customer. For example, the application or website of the third party vendor 22 may collect and store data about the customer, such as preferences or the like, which can be manually entered by the customer or can be collected through monitoring of the customer's shopping activity and coupon 16 use. In this way, retailers 12 and manufacturers 14 can advertise to potential customers through the system, which would provide an additional avenue of revenue to the third party vendor 22. Advertising and coupons 16 can also be targeted to customers using geolocation data from the mobile device 18, date and time, the type of mobile device 18, and the like.

In another embodiment, the web site, mobile application, or the like may have functionality that allows the customer to store “favorites,” that is a list of one or more products which the customer buys repeatedly and for which the customer would be consistently interested in receiving coupons. The favorites may be entered manually by the customer, may be automatically compiled based on customer shopping history, or the like. In one example, during a shopping trip, the web site or mobile application may inquire whether the customer wishes to check for coupons related to the favorites list, in response to which the customer may designate all, some, or none, depending on the customer's shopping needs or the like. In another example, the customer may have the option to have coupons related to the favorites automatically be retrieved for each shopping trip.

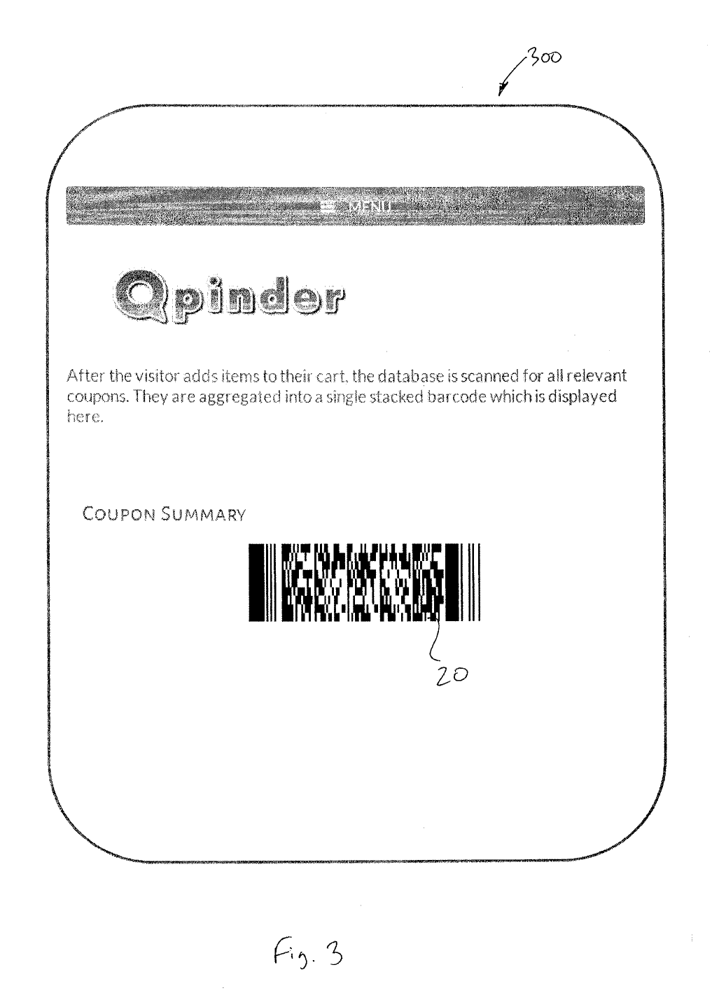

Once the customer has completed shopping or otherwise settled on the coupons 16 desired to be used, the consolidated coupon code 20 is preferably generated by including all of the relevant information and data from the selected coupons 16, such as product IDs, redemption values, expiration dates, or like information. FIG. 3 is a screenshot 300 of the application which displays the resultant consolidated coupon code 20. It is preferred that the consolidated coupon code 20 can simply be displayed on the mobile device 18 and scanned at the POS terminal of the retailer 14. However, there may also be an option to print the consolidated coupon code 20 on paper or other necessary media, which may be the through a customer's own printer, a printer at the retailer 12, or the like. In embodiments where the customer is accessing a website or the like from a computer other than the mobile device 18, such as the kiosk or the customer's home computer, the customer preferably has the option to send the consolidated coupon code 20 to the mobile device 18 via e-mail, text message, SMS, or the like. In addition, a link may be provided to a web page displaying the consolidated coupon code 20 which can be accessed by a browser, the application, or the like on the mobile device 18.

In another embodiment, the consolidated coupon code 20 can be stored in the database and can be accessed by the retailer 14 using other affiliated information. For example, the database may affiliate the consolidated coupon code 20 with a customer loyalty rewards card, customer phone number, or other unique identifier that is capable of, upon receipt of the affiliated identifier by the POS terminal of the retailer 14, returning the consolidated coupon code 20 in response. For such an embodiment, the retailer 14 would require access to the third party vendor server, or at least to an interface capable of negotiating with the server, in order to retrieve the consolidated coupon code 20.

The system and method according to embodiments of the present invention is also intended to assist retailers 12 in redeeming the used coupons 16 from the manufacturer 14 in appropriate circumstances. FIG. 4 is a flow chart of one embodiment of an application utilized by the retailer 12 to electronically organize and redeem the coupons 16 received from the customer via the consolidated coupon code 20.

At step 400, proof of purchase data is preferably correlated with the coupon data received from the consolidated coupon code 20. The proof of purchase data can be, for example, a scanned or electronic copy of a receipt from the corresponding transaction (showing the sale of the applicable product and use of the coupon 16), or the like. At step 402, data related to (e.g., identifying) each individual coupon 16 is sorted. For example, each coupon 16 may be listed individually, coupons 16 from the same manufacturer 14 may be grouped together, coupons 16 offered by the retailer 12 may be grouped together, or the like. The proof of purchase data remains with each coupon 16 or group of coupons 16 for validation purposes. At step 404, at least a portion of the sorted coupon data may be stored and/or electronically sent to a recipient, which could be a headquarters of the retailer 12, a manufacturer 14, a coupon clearinghouse (not shown) or the like. The recipient thereafter can calculate a total reimbursement value for the applicable coupons 16 and initiate payment.

Those skilled in the art will recognize that boundaries between the above-described steps in FIG. 4 are merely illustrative. The multiple steps may be combined into a single step, a single step may be distributed in additional steps and steps may be executed at least partially overlapping in time. Further, alternative embodiments may include multiple instances of a particular step, and the order of steps may be altered in various other embodiments. It is contemplated that the retailer 12 redemption process may be executed on a periodic basis, such as daily, weekly, monthly, or the like, may be executed each time a consolidated coupon code 20 is scanned, or the like.

In another embodiment, retailers 12 and manufacturers 14 can be part of an integrated network, which may or may not be operated by a third party vendor 22, for ease of redemption. For example, the database described above from which customers may select coupons 16 for use can also facilitate the retailer 12 and manufacturer 14 interactions. After receiving data from a consolidated coupon code 20, a terminal, computer, or the like at the retailer 12 may send an identifier of one or more of the various coupons 16 used by the customer, along with proof of purchase (e.g., receipt copy), to the third party vendor 22, the manufacturer 14 or the like. The recipient may access the database to determine appropriate reimbursement values based on the identifier(s) provided from the retailer 12.

Although it is preferred to eliminate the use of paper and prevent fraud in the redemption process, in other embodiments, the retailer 12 may print out one or more copies of the coupons 16 used by the customer and redeem the coupons 16 in the conventional fashion by shipping the paper copies to the appropriate entities. The above-described methods for coupon 16 redemption by the retailer 12 are exemplary only, and the invention should not be considered so limited.

In another embodiment, the user interface provided to the customer can additionally provide other services, such as price-matching searches for desired products. For example, the user interface can be used to search similar stores or nearby locations for the same product and compare prices to allow the customer to make an informed purchasing decision. This can further include consideration of whether one or more coupons for the product may be accepted at each of the locations. Other shopping services, such as price-checks, nutritional information, calculator, sale promotions, or the like, or non-shopping services, such as weather, financial, or like information, can also be provided.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A system for presenting a plurality of coupons at a retail check-out, the system comprising:
a server including a database storing coupon data related to a plurality of coupons, each of the coupons being associated with at least one of a plurality of products available for purchase at one or more retailers, the coupon data for each of the plurality of coupons including at least a product ID and a redemption value; and
a user interface operated and displayed by a customer computing device in communication with the server, the user interface being configured to accept an input by the customer of an identification code for each of a plurality of customer-selected products and send the identification codes for the plurality of customer-selected products to the server,
wherein the server is configured to:
(i) search the database, using the received identification codes, for coupons associated with the customer-selected products,
(ii) create a single machine-readable consolidated coupon code from two or more coupons located in the search, the consolidated coupon code including the product ID and redemption value for each of the two or more coupons located in the search, and
(iii) send the consolidated coupon code to the customer computing device for presentation to a cashier to obtain the redemption values of the two or more coupons during a purchase of the plurality of customer-selected products.

2. The system of claim 1, wherein the user interface is further configured to access a camera of the customer computing device to receive the identification codes from the plurality of customer-selected products.

3. The system of claim 2, wherein the identification codes are in the form of UPCs.

4. The system of claim 1, wherein, prior to creation of the consolidated coupon code by the server, the user interface is further configured to present each coupon located in the search to the customer and receive an indication of acceptance or rejection of each such coupon.

5. The system of claim 4, wherein the server is further configured to create the consolidated coupon code from two or more coupons located in the search that were accepted by the customer.

6. The system of claim 1, wherein the consolidated coupon code is in the form of at least one of a two-dimensional bar code or a three-dimensional bar code.

7. The system of claim 6, wherein the consolidated coupon code is in the form of at least one of a stacked barcode, a PDF417 code, or a QR code.

8. The system of claim 1, wherein the user interface is further configured to present the consolidated coupon code on a display of the customer computing device for presentation to the cashier.

9. The system of claim 1, wherein user interface is further configured to provides the customer with an option to print a hard copy of the consolidated coupon code for presentation to the cashier.

10. A method for presenting a plurality of coupons at a retail check-out, the method comprising:
providing, in a server, a database storing coupon data related to a plurality of coupons, each of the coupons being associated with at least one of a plurality of products available for purchase at one or more retailers, the coupon data for each of the plurality of coupons including at least a product ID and a redemption value;
receiving, at the server from a customer computing device, identification codes for each of a plurality of customer-selected products;
searching, by the server, the database, using the received identification codes, for coupons associated with the customer-selected products;
creating, by the server, a single machine-readable consolidated coupon code from two or more coupons located in the search, the consolidated coupon code including the product ID and redemption value for each of the two or more coupons located in the search; and
sending, by the server, the consolidated coupon code to the customer computing device for presentation to a cashier to obtain the redemption values of the two or more coupons during a purchase of the plurality of customer-selected products.

11. The method of claim 10, further comprising:
prior to creation of the consolidated coupon code, sending, by the server, each coupon located in the search to the customer computing device; and
receiving, at the server from the customer computing device, an indication of acceptance or rejection of each coupon sent to the customer computing device.

12. The method of claim 11, wherein the server creates the consolidated coupon code from two or more coupons located in the search that were accepted by the customer.

13. The method of claim 10, wherein the consolidated coupon code is in the form of at least one of a two-dimensional bar code or a three-dimensional bar code.

14. The method of claim 13, wherein the consolidated coupon code is in the form of at least one of a stacked barcode, a PDF417 code, or a QR code.

15. A method for presenting a plurality of coupons at a retail check-out, the method comprising:
providing a user interface operated and displayed by a customer computing device in communication with a server, the server including a database storing coupon data related to a plurality of coupons, each of the coupons being associated with at least one of a plurality of products available for purchase at one or more retailers, the coupon data for each of the plurality of coupons including at least a product ID and a redemption value;
accepting, by the user interface, an input by the customer of an identification code for each of a plurality of customer-selected products;
sending, by the customer computing device, the identification codes for the plurality of customer-selected products to the server;
receiving, at the customer computing device from the server, a single machine-readable consolidated coupon code from two or more coupons located in a search conducted by the server of the database for coupons associated with the customer-selected products using the sent identification codes, the consolidated coupon code including the product ID and redemption value for each of the two or more coupons located in the search; and
presenting, by the user interface on a display of the customer computing device, the consolidated coupon code to a cashier to obtain the redemption values of the two or more coupons during a purchase of the plurality of customer-selected products.

16. The method of claim 15, wherein the user interface accesses a camera of the customer computing device to receive the identification codes from the plurality of customer-selected products.

17. The method of claim 16, wherein the identification codes are in the form of UPCs.

18. The method of claim 15, wherein the consolidated coupon code is in the form of at least one of a two-dimensional bar code or a three-dimensional bar code.

19. The method of claim 18, wherein the consolidated coupon code is in the form of at least one of a stacked barcode, a PDF417 code, or a QR code.
